(19) United States
(12) Patent Application Publication
(10) Pub. No.: US 2025/0224137 A1
(43) Pub. Date: Jul. 10, 2025

(54) AIR CONDITIONING APPARATUS AND AIR PURIFIER

(71) Applicant: DAIKIN INDUSTRIES, LTD., Osaka (JP)

(72) Inventors: Shota YAMADA, Osaka (JP); Tomohiro ISHIBASHI, Osaka (JP); Kaname MARUYAMA, Osaka (JP)

(21) Appl. No.: 19/088,646

(22) Filed: Mar. 24, 2025

Related U.S. Application Data
(63) Continuation of application No. PCT/JP2023/033957, filed on Sep. 19, 2023.

(30) Foreign Application Priority Data
Sep. 30, 2022 (JP) 2022-158801

(51) Int. Cl. F24F 13/24; F24F 8/108; F24F 13/02

(52) U.S. Cl. CPC F24F 13/24; F24F 13/0236; F24F 8/108

(57) ABSTRACT

An air conditioning apparatus includes a housing, a fan arranged in an inside of the housing, a suction-side flow path between a suction opening of the housing and a suction port of the fan, and a silencer with a tubular shape. The silencer has a propagation path through which a sound propagates. The silencer includes an opening that is open at one end of the propagation path and communicates with the suction-side flow path, and a blocking part that blocks an other end of the propagation path and reflects, toward the opening, the sound that has passed through the propagation path.

### CROSS-REFERENCE TO RELATED APPLICATIONS

This is a continuation of International Application No. PCT/JP2023/033957 filed on Sep. 19, 2023, which claims priority under 35 U.S.C. § 119(a) to Patent Application No. 2022-158801, filed in Japan on Sep. 30, 2022, all of which are hereby expressly incorporated by reference into the present application.

### BACKGROUND

### Technical Field

The present disclosure relates to an air conditioning apparatus and an air purifier.

### Background Information

Japanese Patent No. 6477798 discloses an air purifier in which a HEPA filter as a first filter and a deodorizing filter as a second filter are arranged so as to be close to each other and opposed to each other on the downstream side of the air flow.

### SUMMARY

A first aspect of the present disclosure is directed to an air conditioning apparatus including: a housing; and a fan arranged in an inside of the housing, the air conditioning apparatus further including: a suction-side flow path between a suction opening of the housing and a suction port of the fan; and a silencer in a tubular shape having a propagation path through which a sound propagates, the silencer including: an opening that is open at one end of the propagation path and communicates with the suction-side flow path; and a blocking part that blocks the other end of the propagation path and reflects, toward the opening, the sound that has passed through the propagation path.

### BRIEF DESCRIPTION OF THE DRAWINGS

FIG. 1 is a front sectional view showing a configuration of an air conditioning apparatus of a first embodiment.

FIG. 2 is a front sectional view for explaining the direction of sound wave propagation.

FIG. 3 is a transverse sectional view showing a configuration of the air conditioning apparatus.

FIG. 4 is a front sectional view showing a configuration of an air conditioning apparatus of a second embodiment.

FIG. 5 is a graph showing the relationship between a frequency and a sound pressure level, with a silencer provided.

FIG. 6 is a graph showing the relationship between a frequency and a sound pressure level, with different lengths of the propagation path of the silencer.

FIG. 7 is a graph showing the relationship between a frequency and the amount of noise reduction, with different volumes of the silencing chamber.

FIG. 8 is a graph showing the relationship between a frequency and the amount of noise reduction, with a silencer provided in the silencing chamber.

FIG. 9 is a graph showing the relationship between the ratio of sectional areas between an opening and a suction-side flow path and the amount of noise reduction.

FIG. 10 is a transverse sectional view for explaining the shape of the opening of the silencer with different aspect ratios.

FIG. 11 is a graph showing the relationship between the frequency and the sound pressure level, with different aspect ratios of the opening of the silencer.

FIG. 12 is a front sectional view showing a configuration of an air conditioning apparatus of a third embodiment.

FIG. 13 is a graph showing the relationship between a frequency and the amount of noise reduction, with a first silencer and a second silencer provided in the silencing chamber.

FIG. 14 is a front sectional view showing a configuration of an air conditioning apparatus of a fourth embodiment.

FIG. 15 is a side sectional view showing the configuration of the air conditioning apparatus.

FIG. 16 is a front sectional view showing a configuration of an air conditioning apparatus of a fifth embodiment.

FIG. 17 is a side sectional view showing the configuration of the air conditioning apparatus.

FIG. 18 is a front sectional view showing a configuration of an air conditioning apparatus of a sixth embodiment.

FIG. 19 is a side sectional view showing the configuration of the air conditioning apparatus.

FIG. 20 is a front sectional view showing a configuration of an air conditioning apparatus of a seventh embodiment.

FIG. 21 is a side sectional view showing the configuration of the air conditioning apparatus.

FIG. 22 is a front sectional view showing a configuration of an air conditioning apparatus of an eighth embodiment.

FIG. 23 is a side sectional view showing the configuration of the air conditioning apparatus.

FIG. 24 is a front sectional view showing a configuration of an air conditioning apparatus of a ninth embodiment.

FIG. 25 is a front sectional view showing a configuration of an air conditioning apparatus of a tenth embodiment.

FIG. 26 is a side sectional view showing the configuration of the air conditioning apparatus.

FIG. 27 is a front sectional view showing the configuration of the air conditioning apparatus, with the illustration of a humidifier omitted.

FIG. 28 is a side sectional view showing the configuration of the air conditioning apparatus, with the illustration of a humidifier omitted.

### DETAILED DESCRIPTION OF EMBODIMENT(S)

### First Embodiment

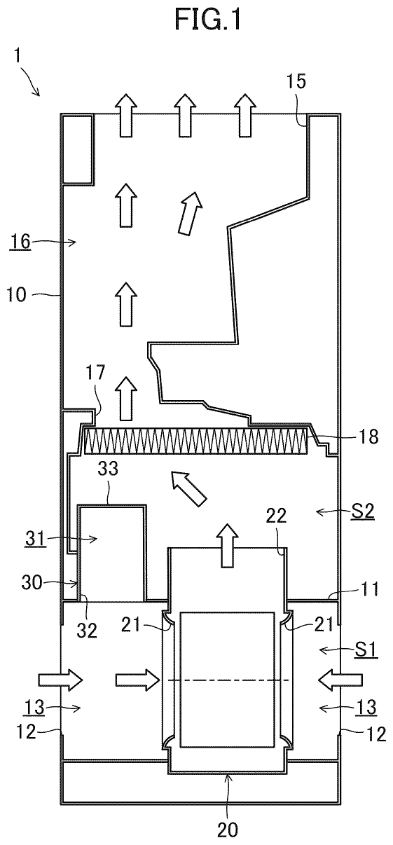

As shown in FIG. 1, an air conditioning apparatus (1) includes a housing (10), a filter (18), and a fan (20). In this embodiment, the air conditioning apparatus (1) is an air purifier.

The housing (10) is in the shape of a vertically long box. The housing (10) is made of, for example, a resin material. A top plate (11) extending in the horizontal direction is arranged in the inside of the housing (10). The inside of the housing (10) is divided into a first space (S1) and a second space (S2) by the top plate (11). The first space (S1) is disposed below the top plate (11). The second space (S2) is disposed above the top plate (11).

The housing (10) has suction openings (12) communicating with the first space (S1). The suction openings (12) are formed in both the right and left walls of the housing (10) in FIG. 1.

The fan (20) is arranged in the first space (S1). The fan (20) is a sirocco fan. Suction ports (21) of the fan (20) are opposed to the suction openings (12) of the housing (10). Accordingly, a suction-side flow path (13) is provided between the suction openings (12) of the housing (10) and the suction ports (21) of the fan (20) in the first space (S1). A blowout port (22) of the fan (20) penetrates the top plate (11) and is open to the second space (S2).

The housing (10) has a blowout opening (15) communicating with the second space (S2). The blowout opening (15) is formed in an upper wall of the housing (10) in FIG. 1.

A blowout-side flow path (16) is provided between the blowout opening (15) of the housing (10) and the blowout port (22) of the fan (20). The filter (18) is disposed in the blowout-side flow path (16). The filter (18) is a high efficiency particulate air (HEPA) filter, for example.

A narrower part (17) at which the flow path area of the blowout-side flow path (16) is narrow is provided on the downstream side of the filter (18) in the blowout-side flow path (16).

When the fan (20) rotates, the air sucked through the suction openings (12) of the housing (10) is sucked into the suction ports (21) of the fan (20) through the suction-side flow path (13), as indicated by the white arrows in FIG. 1. The air sucked into the fan (20) is blown out from the blowout port (22) into the blowout-side flow path (16) of the second space (S2). The dust contained in the air blown into the blowout-side flow path (16) is collected while the air passes through the filter (18). The air after removal of the dust is blown out from the blowout opening (15) of the housing (10).

### Silencer

In the air conditioning apparatus (1), a prominent sound occurs when the fan (20) is operated. The sound generated on the blow-out side of the fan (20) is insulated by the filter (18). It is thus possible to reduce the sound generated on the blow-out side of the fan (20).

On the other hand, the arrangement of the filter (18) increases the pressure loss in the flow path on the blow-out side of the fan (20). The provision of the narrower part (17) in the blowout-side flow path (16) also increases the pressure loss in the flow path on the blow-out side of the fan (20).

As a result, the number of rotations of the fan (20) increases, which may cause louder sounds on the suction side of the fan (20).

Accordingly, in this embodiment, a silencer (30) is provided to reduce the sound generated on the suction side of the fan (20).

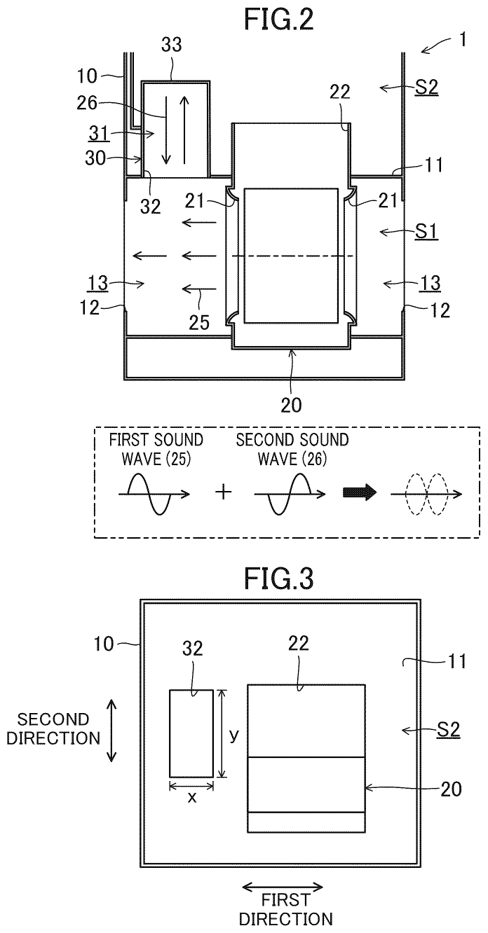

Specifically, as illustrated in FIG. 2, the silencer (30) is in a tubular shape having a propagation path (31) through which a sound propagates. The silencer (30) includes an opening (32) and a blocking part (33). The opening (32) is open at one end (i.e., the lower end in FIG. 2) of the propagation path (31) and communicates with the suction-side flow path (13). The blocking part (33) blocks the other end (i.e., the upper end in FIG. 2) of the propagation path (31) and reflects the sound that has passed through the propagation path (31) toward the opening (32). In FIG. 2, the direction of sound wave propagation is indicated by arrows.

The sound generated in the suction-side flow path (13) is a prominent sound caused by the rotation of the fan (20) or a prominent sound caused by a resonance sound due to the shape of the housing (10).

As illustrated in FIG. 3, the direction in which the sound propagates through the suction-side flow path (13) is referred to as a first direction, and a direction orthogonal to the first direction is referred to as a second direction. The shape of the opening (32) is set so that the opening (32) of the silencer (30) has an average length greater in the second direction than in the first direction.

Specifically, the average length of the opening (32) of the silencer (30) in the first direction is labeled with x, and the average length of the opening (32) of the silencer (30) in the second direction is labeled with y; the average length y in the second direction is greater than the average length x in the first direction.

As illustrated in FIG. 2, the silencer (30) is attached to the top plate (11) that divides the first space (S1). The top plate (11) has a hole corresponding to the opening (32) of the silencer (30). Part of a first sound wave (25) generated by the fan (20) and propagating through the suction-side flow path (13) passes through the propagation path (31) from the opening (32) of the silencer (30). The sound wave passing through the propagation path (31) is reflected by the blocking part (33) to become a second sound wave (26) having a reversed phase. The second sound wave (26) passes through the propagation path (31) and is emitted from the opening (32).

Accordingly, the first sound wave (25) propagating through the suction-side flow path (13) and the second sound wave (26) emitted from the silencer (30) are superimposed on each other, so that part of the first sound wave (25) and the second sound wave (26) cancel each other. This can reduce the sound propagating through the suction-side flow path (13).

### Advantages of First Embodiment

According to the features of this embodiment, it is possible to reduce a prominent sound generated in the suction-side flow path (13) by letting the sound generated in the suction-side flow path (13) propagate to the propagation path (31) of the silencer (30) and reflected by the blocking part (33) of the silencer (30), and superimposing the sound waves having reversed phases at the opening (32).

According to the features of this embodiment, the opening (32) of the silencer (30) has an average length greater in the second direction than in the first direction. It is possible to enhance the noise reduction effect by devising the shape of the opening (32) of the silencer (30) in this manner.

According to the features of this embodiment, it is possible to reduce the sound caused by the rotation of the fan (20).

According to the features of this embodiment, it is possible to reduce the sound caused by the resonance sound due to the shape of the housing (10).

### Second Embodiment

In the following description, the same reference characters designate the same components as those of the first embodiment, and the description is focused only on the differences.

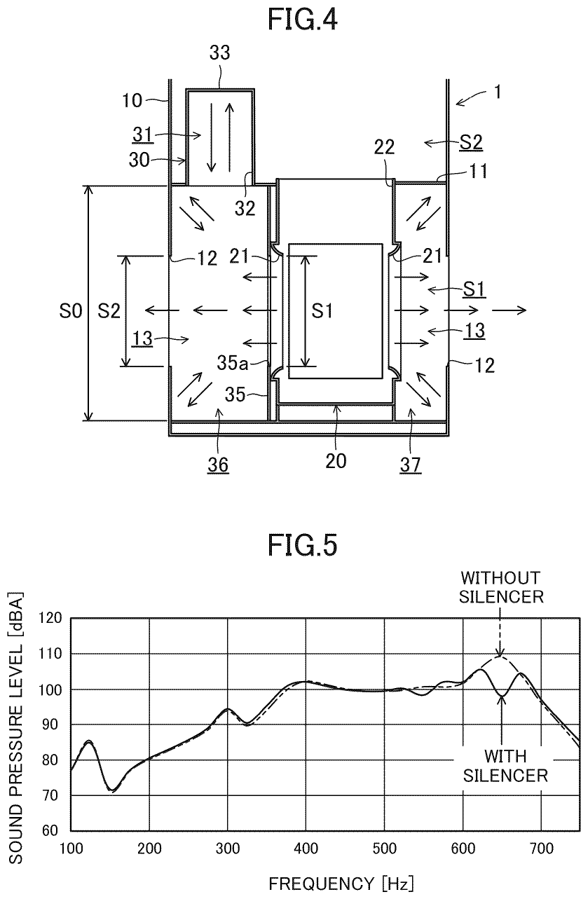

As illustrated in FIG. 4, the inside of the housing (10) is divided into the first space (S1) and the second space (S2) by the top plate (11).

The first space (S1) is provided with a partition plate (35). The partition plate (35) extends in the up-down direction in the first space (S1). The partition plate (35) divides the inside of the first space (S1) into a fan chamber (37) and a silencing chamber (36). The fan (20) is disposed in the fan chamber (37). The silencing chamber (36) propagates sounds on the upstream side of the air fan chamber (37) in the direction of air flow. In FIG. 4, the direction of sound wave propagation is indicated by arrows.

A communication port (35a) communicating with a suction port (21) of the fan (20) is formed in the partition plate (35). The suction-side flow path (13) includes the silencing chamber (36). The silencer (30) is disposed on the side closer to the silencing chamber (36) in the suction-side flow path (13). The opening (32) of the silencer (30) communicates with the silencing chamber (36).

In this embodiment, the conditions of S1<S0 and S2<S0 are satisfied, where S0 is a cross-sectional area of the silencing chamber (36) in a direction orthogonal to the axis of the fan (20), S1 is a cross-sectional area of each suction port (21) of the fan (20), and S2 is a cross-sectional area of each suction opening (12) of the housing (10). The volume of the silencer (30) is set to be smaller than the volume of the silencing chamber (36).

As indicated by the arrows in FIG. 4, in the silencing chamber (36), the sound waves generated by the fan (20) and propagating through the suction-side flow path (13) propagate toward the corners between the walls of the housing (10) and the top plate (11), which constitute the silencing chamber (36), and are then reflected. Accordingly, the sound waves propagating through the inside of the silencing chamber (36) is reduced by the sound waves having reversed phase.

Although the silencing chamber (36) has the silencing effect for a wide range of frequencies, there may be a resonance sound dependent on the volume space at a specific frequency. According to this embodiment, the silencer (30) is provided in the silencing chamber (36), which allows the sound waves that have not been reduced enough in the silencing chamber (36) to propagate through the propagation path (31) of the silencer (30) and be reflected, thereby making it possible to further reduce the sound waves in the silencing chamber (36).

Specifically, as shown in the graph of FIG. 5, without a silencer (30) in the silencing chamber (36), the noise of 111 dBA occurs at the frequency of 650 Hz. On the other hand, with a silencer (30) in the silencing chamber (36), the noise is reduced to 100 dBA at the frequency of 650 Hz: it is found that the noise reduction effect is obtainable.

### Length of Propagation Path of Silencer

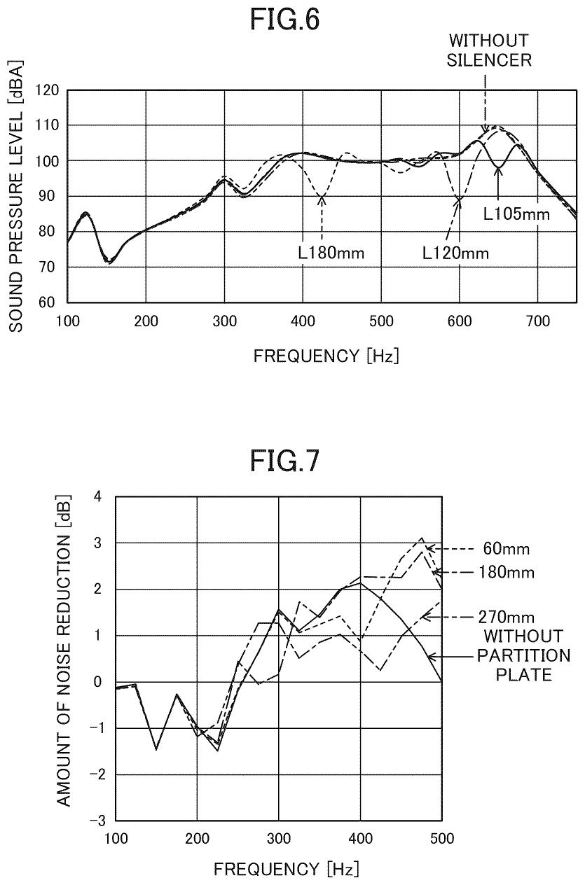

The length of the propagation path (31) of the silencer (30) is preferably set in accordance with the frequency of the sound. Specifically, as shown in the graph of FIG. 6, the length of the propagation path (31) of the silencer (30) is set, for example, to 105 mm, 120 mm, and 180 mm, for analysis of sound pressure levels. It is found that silencer (30) having longer propagation path (31) has the higher noise reduction effect in a lower frequency range. It is also found that even when the length of the propagation path (31) is changed, the width of the frequency at which the noise reduction effect is obtained is constant and the width is about 50 Hz.

It is thus possible to enhance the noise reduction effect of the silencer (30) by setting the length of the propagation path (31) in accordance with the sound frequency.

### Volume of Silencing Chamber

Next, a change in the amount of noise reduction will be described with different volumes of the silencing chamber (36). As illustrated in FIG. 4, the volume of the silencing chamber (36) is defined by the position of the partition plate (35) in the right-to-left direction. The inventers have studied how the amount of noise reduction changes when the distance from the left wall of the housing (10) in FIG. 4 to the partition plate (35) is changed.

In the graph of FIG. 7, the amount of noise reduction is compared between the case in which the partition plate (35) is not provided and the cases in which the distance from the wall of the housing (10) to the partition plate (35) is set to be 60 mm, 180 mm, and 270 mm. In the graph of FIG. 7, a case without the silencer (30) is studied.

As shown in FIG. 7, cases with the partition plate (35) and thus the silencing chamber (36) have peak frequencies with a great effect of reducing the amount of noise reduction, as compared to the case without the partition plate (35). On the other hand, it is found that even if the volume of the silencing chamber (36) is changed, there is a region, at the same point, in which the amount of noise reduction is reduced due to the resonance sound dependent on the volume of the suction-side flow path (13).

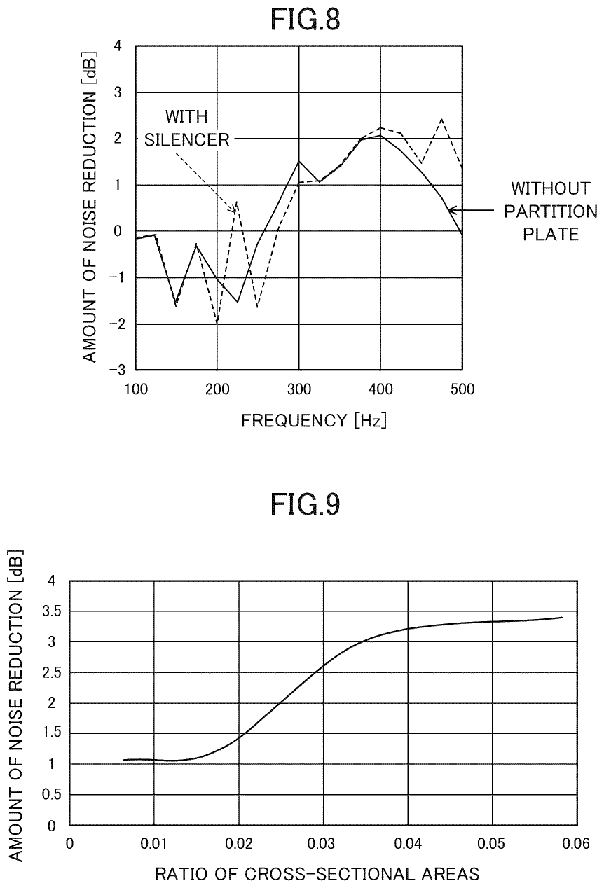

By contrast, as shown in FIG. 8, in a case in which the silencer (30) is provided for the silencing chamber (36), it is found that sound waves not completely eliminated in the silencing chamber (36) are cancelled out by the sound waves reflected by the blocking part (33) of the silencer (30), thereby making it possible to shift the resonance sound of the silencing chamber (36) to a lower frequency range.

### Cross-Sectional Area of Opening of Silencer

The cross-sectional area of the opening (32) of the silencer (30) is preferably set as follows. As illustrated in FIG. 4, S represents the cross-sectional area of the opening (32) of the silencer (30), and S0 represents the cross-sectional area of the suction-side flow path (13) in a direction orthogonal to the axis of the fan (20).

As shown in the graph of FIG. 9, it is found that the amount of noise reduction tends to increase in the range of 0.02<S/S0<0.05. In view of this, in this embodiment, the cross-sectional area of the opening (32) of the silencer (30) is set to satisfy the condition of 0.02<S/S0<0.05.

### Shape of Opening of Silencer

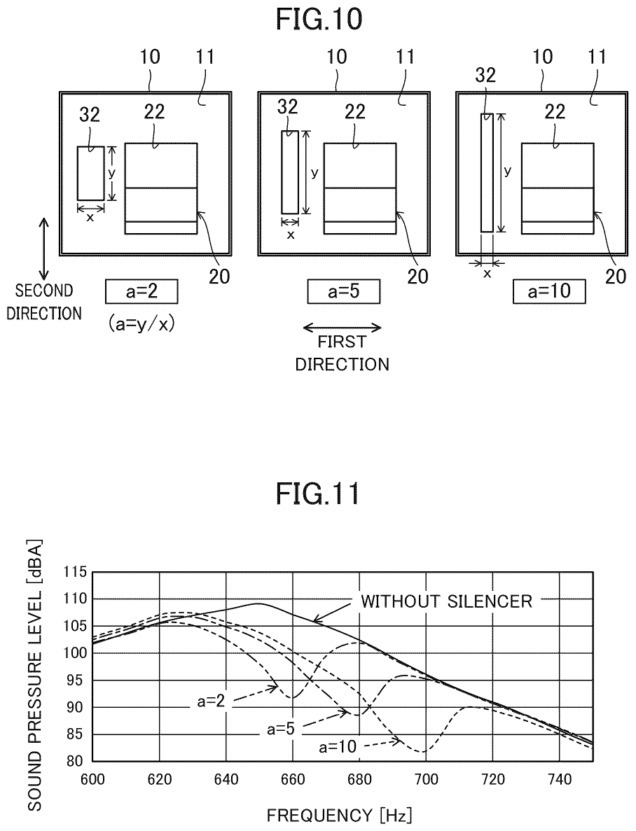

Next, the influence of the shape of the opening (32) of the silencer (30) on the sound pressure level is examined. As illustrated in FIG. 10, the direction in which the sound propagates through the suction-side flow path (13) is referred to as a first direction, and a direction orthogonal to the first direction is referred to as a second direction. The opening (32) of the silencer (30) has a rectangular shape. The average length of the opening (32) of the silencer (30) in the first direction is labeled with x, and the average length of the opening (32) of the silencer (30) in the second direction is labeled with y. The aspect ratio a is calculated based on a=y/x. The cross-sectional area of the opening (32) of the silencer (30) is set to be constant.

Higher aspect ratio a makes the average length y in the second direction greater than the average length x in the first direction. As shown in the graph of FIG. 11, it is found the higher aspect ratio makes the frequency bandwidth having the noise reduction effect wider.

Here, the wider frequency bandwidth may be the result of the improvement of the sound diffraction effect due to a change in the cross-sectional shape. The area in which the diffraction occurs is widened, and the amount of sound waves entering the silencer (30) is increased, by increasing the length of the opening (32) in the second direction orthogonal to the first direction to be greater than the length in the first direction which is the direction in which the sound propagates. As a result, the amount of sound waves reflected by the silencer (30) also increases, which enhances the noise reduction effect in a wide frequency band, mainly the resonance frequency of the silencer (30).

### Advantages of Second Embodiment

According to features of this embodiment, it is possible to enhance the noise reduction effect by setting the cross-sectional area of the opening (32) of the silencer (30) properly.

According to the features of this embodiment, it is possible to enhance the noise reduction effect of the silencer (30) by setting the length of the propagation path (31) in accordance with the sound frequency.

According to the features of this embodiment, it is possible to reduce the sound using the sound waves reflected by the partition plate (35) and the walls of the housing (10) in the silencing chamber (36) having a larger volume than the silencer (30), and is possible to cancel out the sound waves not completely eliminated in the silencing chamber (36), using the sound waves reflected by the blocking part (33) of the silencer (30).

According to the features of this embodiment, it is possible to reduce the resonance sound dependent on the volume of the suction-side flow path (13).

According to the features of this embodiment, it is possible to form the silencing chamber (36) by dividing the inside of the housing (10) with the partition plate (35). The noise reduction effect is obtainable also in the case in which the inside of the suction-side flow path (13) serves as the silencing chamber (36) without the partition plate (35).

### Third Embodiment

In the following description, the same reference characters designate the same components as those of the second embodiment, and the description is focused only on the differences.

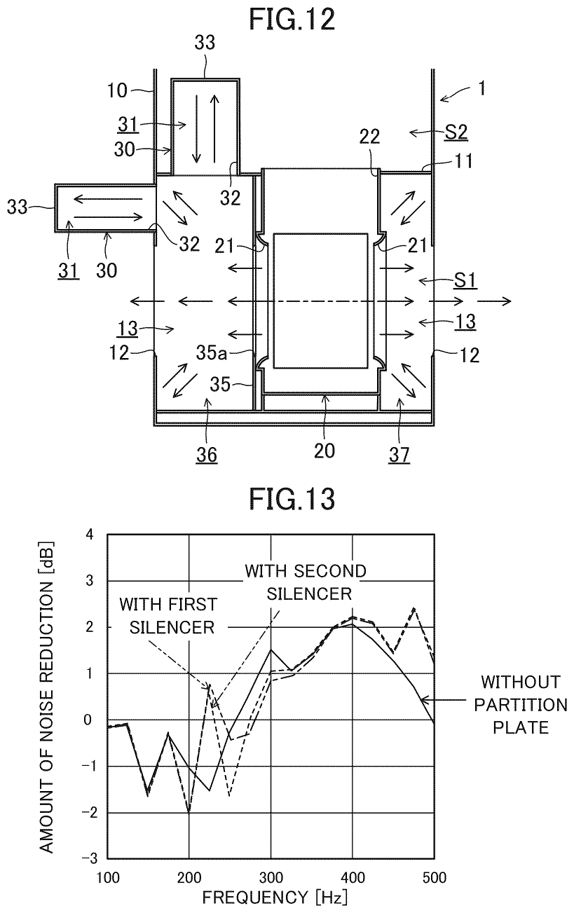

As illustrated in FIG. 12, the inside of the housing (10) is divided into the first space (S1) and the second space (S2) by the top plate (11).

The first space (S1) is provided with a partition plate (35). The partition plate (35) extends in the up-down direction in the first space (S1). The partition plate (35) divides the inside of the first space (S1) into a fan chamber (37) and a silencing chamber (36). The fan (20) is disposed in the fan chamber (37). The silencing chamber (36) propagates sounds on the upstream side of the air fan chamber (37) in the direction of air flow. In FIG. 12, the direction of sound wave propagation is indicated by arrows.

A communication port (35a) communicating with a suction port (21) of the fan (20) is formed in the partition plate (35). The suction-side flow path (13) includes the silencing chamber (36).

A plurality of silencers (30) are provided. Two silencers (30) are provided in the example illustrated in FIG. 12. One of the two silencers (30) is disposed on a wall of the housing (10), and the other is disposed on the top plate (11). In the following description, the silencer (30) on the wall of the housing (10) is referred to as a first silencer (30), and the silencer (30) disposed on the top plate (11) is referred to as a second silencer (30).

The first silencer (30) is provided on the left wall of the housing (10) in FIG. 12. The propagation path (31) of the first silencer (30) extends in the right-to-left direction in FIG. 12. The opening (32) of the first silencer (30) is open in the first direction (to the right in FIG. 12) which is the same direction as the direction of sound propagation in the silencing chamber (36).

The second silencer (30) is provided on the top plate (11). The propagation path (31) of the second silencer (30) extends in the up-down direction in FIG. 12. The opening (32) of the second silencer (30) is open in the second direction (downward in FIG. 12) orthogonal to the first direction.

As shown in the graph of FIG. 13, in both cases in which the first silencer (30) is provided and the second silencer (30) is provided, it is found that sound waves not completely eliminated in the silencing chamber (36) are cancelled out by the sound waves reflected by the blocking part (33) of the silencer (30), thereby making it possible to shift the resonance sound of the silencing chamber (36) to a lower frequency range.

It is also found that the first silencer (30), in which the opening (32) is open in the same direction as the direction of sound propagation in the silencing chamber (36), reduces a larger amount of noise than the second silencer (30).

### Advantages of Third Embodiment

According to the features of this embodiment, the opening (32) of the silencer (30) is open in the same direction as the direction of sound propagation in the suction-side flow path (13), thereby making it possible to increase the amount of sound waves entering the propagation path (31) of the silencer (30) and enhance the noise reduction effect.

According to the features of this embodiment, it is possible to further enhance the noise reduction effect by providing the plurality of silencers (30).

### Fourth Embodiment

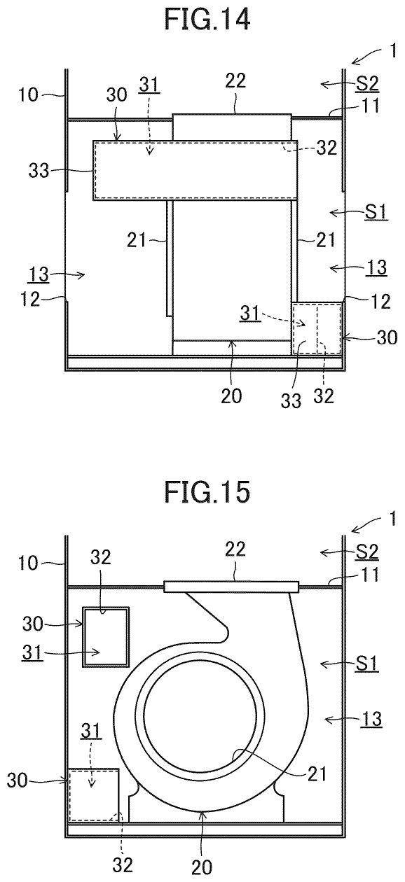

As illustrated in FIGS. 14 and 15, the inside of the housing (10) is divided into a first space (S1) and a second space (S2) by the top plate (11). FIG. 15 is a side sectional view of the housing (10) of FIG. 14 as viewed from the left.

A plurality of silencers (30) are arranged in the first space (S1). In the example shown in FIGS. 14 and 15, two silencers (30) are provided.

An upper silencer (30) in FIG. 14 is arranged closer to the front side of the paper of FIG. 14 than the fan (20). The upper silencer (30) has a propagation path (31) extending in the right-to-left direction. The upper silencer (30) has an opening (32) on the right side in FIG. 14 (on the front side of the paper of FIG. 15). The upper silencer (30) has a blocking part (33) on the left side in FIG. 14 (on the back side of the paper of FIG. 15). Accordingly, the opening (32) of the upper silencer (30) is open in the first direction which is the same as the direction of sound propagation in the suction-side flow path (13).

A lower silencer (30) in FIG. 14 is arranged on the lower right of the fan (20) in FIG. 14. The lower silencer (30) has a propagation path (31) extending toward the back of the paper. The lower silencer (30) has an opening (32) on the back side of the paper of FIG. 14 (on the right side of FIG. 15). The lower silencer (30) has a blocking part (33) on the front side of the paper of FIG. 14 (on the left side of FIG. 15). Accordingly, the opening (32) of the lower silencer (30) is open in the second direction orthogonal to the first direction.

### Advantages of Fourth Embodiment

According to the features of this embodiment, the silencers (30) are arranged in the housing (10), thereby making it possible to save the space for the entire device. It is also possible to further enhance the noise reduction effect by providing the plurality of silencers (30).

### Fifth Embodiment

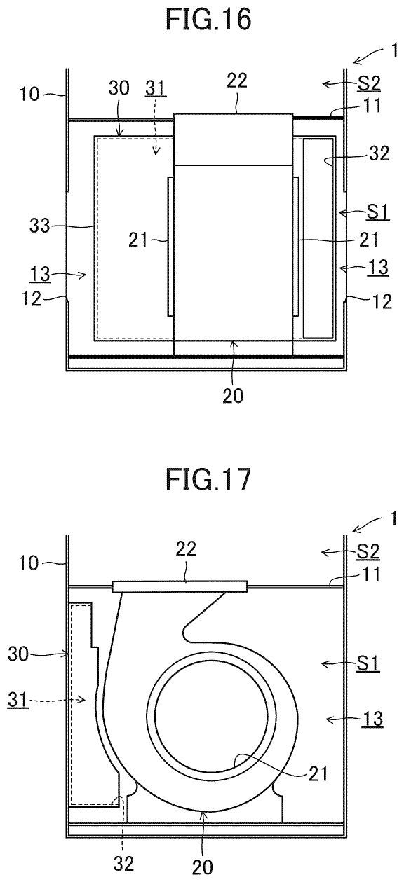

As illustrated in FIGS. 16 and 17, the inside of the housing (10) is divided into a first space (S1) and a second space (S2) by the top plate (11). FIG. 17 is a side sectional view of the housing (10) of FIG. 16 as viewed from the left.

A silencer (30) is arranged in the first space (S1). The silencer (30) is closer to the back side of the paper of FIG. 16 than the fan (20). The silencer (30) has a propagation path (31) extending in the right-to-left direction. The silencer (30) has an opening (32) on the right side and on the front side of the paper of FIG. 16 (on the back side of the paper and on the right side in FIG. 17). The silencer (30) has a blocking part (33) on the left side in FIG. 16 (on the front side of the paper of FIG. 17).

As illustrated in FIG. 17, the opening (32) of the silencer (30) is arranged along the outer peripheral edge of the suction port (21) as viewed along the axis of the fan (20). Specifically, the surface of the silencer (30) where the opening (32) is open has a shape along the outer peripheral edge of the body of the fan (20).

### Advantages of Fifth Embodiment

According to the features of this embodiment, it is possible to arrange the silencer (30) at a position that is near the suction ports (21) of the fan (20) and not interrupting the flow of the air to be sucked into the fan (20).

### Sixth Embodiment

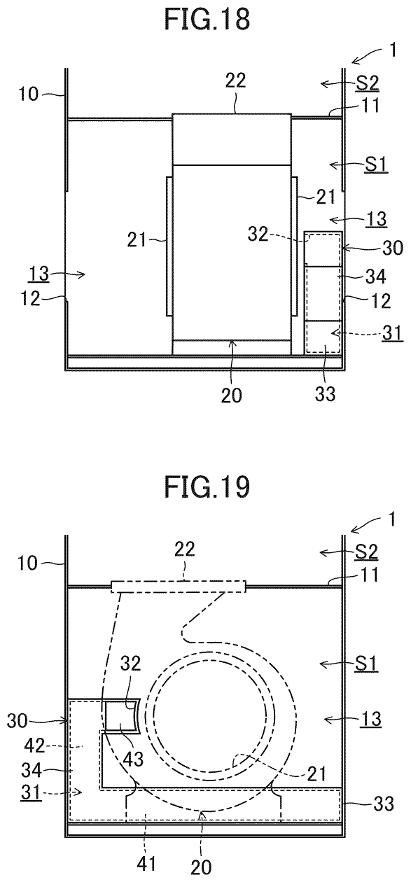

As illustrated in FIGS. 18 and 19, the inside of the housing (10) is divided into a first space (S1) and a second space (S2) by the top plate (11). FIG. 19 is a side sectional view of the housing (10) of FIG. 18 as viewed from the left.

A silencer (30) is arranged in the first space (S1). The silencer (30) is arranged on the right side of the fan (20) in FIG. 18.

The silencer (30) includes a propagation path (31), an opening (32), a blocking part (33), and a bent part (34). The bent part (34) is formed by bending part of the propagation path (31).

As illustrated in FIG. 19, the propagation path (31) of the silencer (30) includes: a first passage (41) extending in the right-to-left direction along the bottom of the housing (10), a second passage (42) bent upward from the left end of the first passage (41) and extending upward along a wall of the housing (10), and a third passage (43) bent rightward from the upper end of the second passage (42) and extending in the right-to-left direction. The bent part (34) includes the second passage (42).

The opening (32) is provided on the front side of the third passage (43) on the paper of FIG. 19. The opening (32) is arranged along the outer peripheral edge of the suction port (21) as viewed along the axis of the fan (20). The blocking part (33) is provided on the right side of the first passage (41) in FIG. 19.

### Advantages of Sixth Embodiment

According to the features of this embodiment, the propagation path (31) of the silencer (30) is bent, thereby making it possible to increase the degree of freedom in the layout of the silencer (30) and increase the total length of the propagation path (31).

According to the features of this embodiment, it is possible to arrange the silencer (30) at a position that is near the suction ports (21) of the fan (20) and not interrupting the flow of the air to be sucked into the fan (20).

### Seventh Embodiment

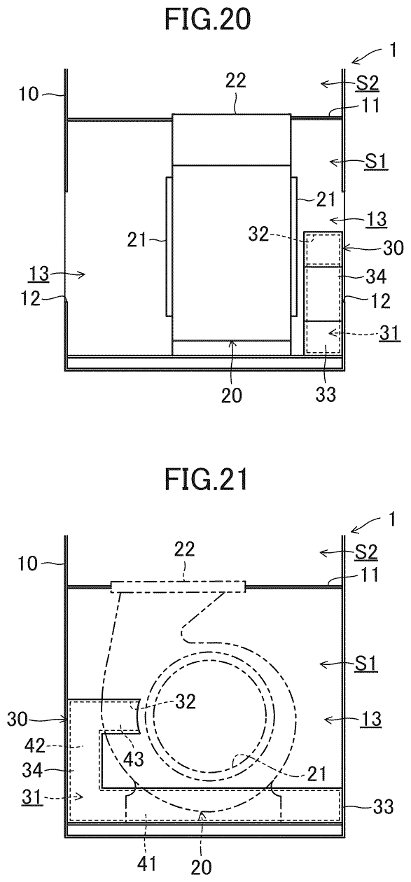

As illustrated in FIGS. 20 and 21, the inside of the housing (10) is divided into a first space (S1) and a second space (S2) by the top plate (11). FIG. 21 is a side sectional view of the housing (10) of FIG. 20 as viewed from the left.

A silencer (30) is arranged in the first space (S1). The silencer (30) is arranged on the right side of the fan (20) in FIG. 20.

The silencer (30) includes a propagation path (31), an opening (32), a blocking part (33), and a bent part (34). The bent part (34) is formed by bending part of the propagation path (31).

As illustrated in FIG. 21, the propagation path (31) of the silencer (30) includes: a first passage (41) extending in the right-to-left direction along the bottom of the housing (10), a second passage (42) bent upward from the left end of the first passage (41) and extending upward along a wall of the housing (10), and a third passage (43) bent rightward from the upper end of the second passage (42) and extending in the right-to-left direction. The bent part (34) includes the second passage (42).

The opening (32) is provided on the right side of the third passage (43) in FIG. 21. The opening (32) is arranged along the outer peripheral edge of the suction port (21) as viewed along the axis of the fan (20). The blocking part (33) is provided on the right side of the first passage (41) in FIG. 21.

### Advantages of Seventh Embodiment

According to the features of this embodiment, the propagation path (31) of the silencer (30) is bent, thereby making it possible to increase the degree of freedom in the layout of the silencer (30) and increase the total length of the propagation path (31).

According to the features of this embodiment, it is possible to arrange the silencer (30) at a position that is near the suction ports (21) of the fan (20) and not interrupting the flow of the air to be sucked into the fan (20).

### Eighth Embodiment

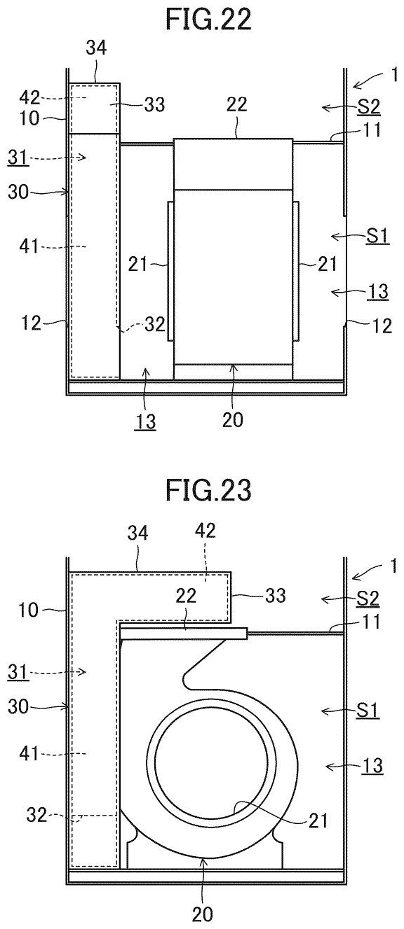

As illustrated in FIGS. 22 and 23, the inside of the housing (10) is divided into a first space (S1) and a second space (S2) by the top plate (11). FIG. 23 is a side sectional view of the housing (10) of FIG. 22 as viewed from the left.

The silencer (30) is arranged to span across the first space (S1) and the second space (S2). The silencer (30) is arranged on the left side of the fan (20) in FIG. 22.

The silencer (30) includes a propagation path (31), an opening (32), a blocking part (33), and a bent part (34). The bent part (34) is formed by bending part of the propagation path (31).

As illustrated in FIG. 23, the propagation path (31) of the silencer (30) includes: a first passage (41) extending upward along the left wall of the housing (10); and a second passage (42) bent rightward from the upper end of the first passage (41) and extending in the right-to-left direction. The bent part (34) includes the second passage (42).

The first passage (41) extends in the up-down direction to span across the first space (S1) and the second space (S2). The second passage (42) extends in the right-to-left direction in the second space (S2).

The opening (32) is provided on the right side of the first passage (41) in FIG. 22 (on the back side of the paper of FIG. 23). The blocking part (33) is provided on the back side of the second passage (42) of the paper of FIG. 22 (on the right side of FIG. 23).

### Advantages of Eighth Embodiment

According to the features of this embodiment, the propagation path (31) of the silencer (30) is bent, thereby making it possible to increase the degree of freedom in the layout of the silencer (30) and increase the total length of the propagation path (31).

### Ninth Embodiment

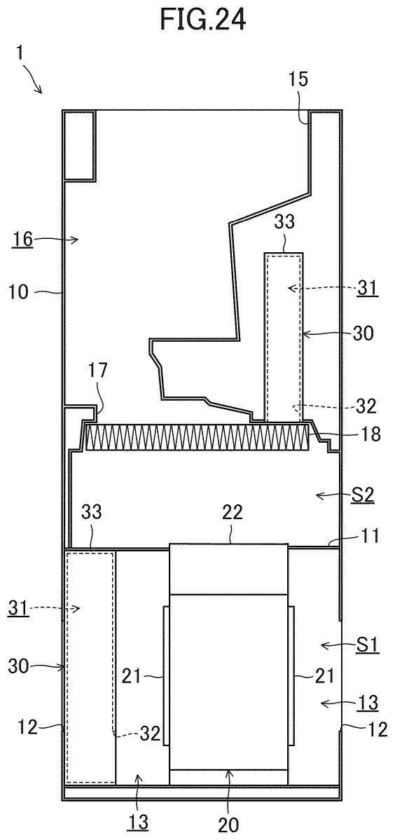

As illustrated in FIG. 24, the inside of the housing (10) is divided into the first space (S1) and the second space (S2) by the top plate (11). The silencers (30) are disposed in the first space (S1) or the second space (S2) one on one.

The silencer (30) in the first space (S1) is arranged on the left side of the fan (20) in FIG. 24. The silencer (30) in the first space (S1) has a propagation path (31) extending in the up-down direction. The silencer (30) in the first space (S1) has an opening (32) on the lower right in FIG. 24. The silencer (30) in the first space (S1) has a blocking part (33) on the upper side in FIG. 24.

The silencer (30) in the second space (S2) is provided on a wall to which the filter (18) is attached. The silencer (30) in the second space (S2) has a propagation path (31) extending in the up-down direction in FIG. 24. The silencer (30) in the second space (S2) has an opening (32) on the lower side in FIG. 24. The silencer (30) in the second space (S2) has a blocking part (33) on the upper side in FIG. 24.

### Advantages of Ninth Embodiment

According to the features of this embodiment, the silencer (30) is provided in each of the first space (S1) on the suction side of the fan (20) and the second space (S2) on the blow-out side of the fan (20), thereby making it possible to enhance the noise reduction effect on both the suction side and the blow-out side of the fan (20).

It will be understood that the embodiments and variations described above can be modified with various changes in form and details without departing from the spirit and scope of the claims. The elements according to the embodiments, the variations thereof, and the other embodiments may be combined and replaced with each other. In addition, the expressions of “first,” “second,” “third,” . . . , in the specification and claims are used to distinguish the terms to which these expressions are given, and do not limit the number and order of the terms.

### Tenth Embodiment

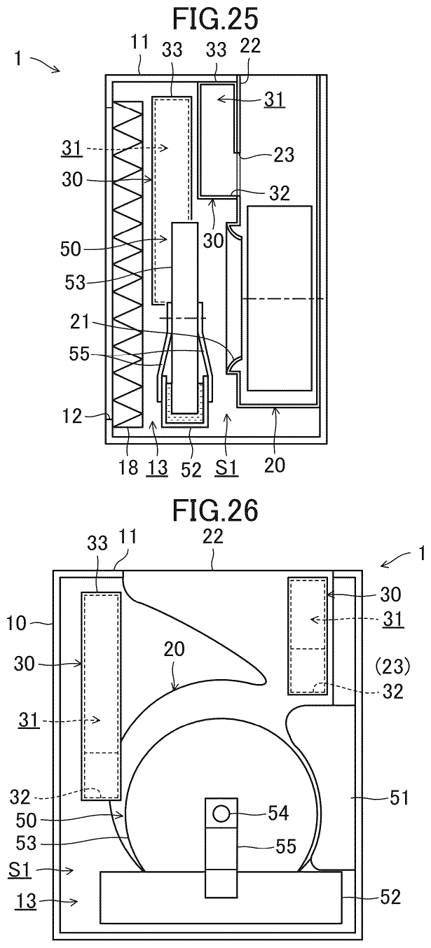

As illustrated in FIGS. 25 and 26, the housing (10) is in the shape of a vertically long box. The inside of the housing (10) includes a first space (S1). The housing (10) has a suction opening (12) communicating with the first space (S1). The suction opening (12) is open in the left wall of the housing (10) in FIG. 25. The filter (18) is arranged in the suction opening (12). FIG. 26 is a side sectional view of the housing (10) of FIG. 25 as viewed from the left.

The fan (20) is arranged in the first space (S1). The fan (20) is a sirocco fan. A suction port (21) of the fan (20) is opposed to the suction opening (12) of the housing (10). Accordingly, a suction-side flow path (13) is provided between the suction opening (12) of the housing (10) and the suction port (21) of the fan (20) in the first space (S1). The blowout port (22) of the fan (20) is open through the top plate (11) of the housing (10).

The air conditioning apparatus (1) includes a humidifier (50). The humidifier (50) has a water supply tank (51), a reservoir (52), and a humidification filter (53).

The water supply tank (51) stores water for humidification. The water supply tank (51) is attachable to and detachable from the housing (10), for example.

The reservoir (52) is in a box shape with an open top. The reservoir (52) stores the water supplied from the water supply tank (51).

The humidification filter (53) has a disk shape. The humidification filter (53) is disposed upstream of the suction port (21) of the fan (20) in the direction of air flow. The lower part of the humidification filter (53) is immersed in the water in the reservoir (52). The part of the humidification filter (53) immersed in the reservoir (52) absorbs and retains water.

The humidification filter (53) is supported rotatably about a shaft (54). The shaft (54) extends between a pair of support legs (55). The proximal ends of the support legs (55) are fixed to the reservoir (52), for example. The humidification filter (53) is rotated about the shaft (54) by a rotation mechanism, such as a motor (not shown). The humidification filter (53) is rotated to make the air pass through the humidification filter (53), thereby releasing the water absorbed in the humidification filter (53) to the suction-side flow path (13). The air containing moisture is sucked into the suction port (21) of the fan (20) and is blown out of the housing (10) through the blowout port (22). The air can be humidified in this manner.

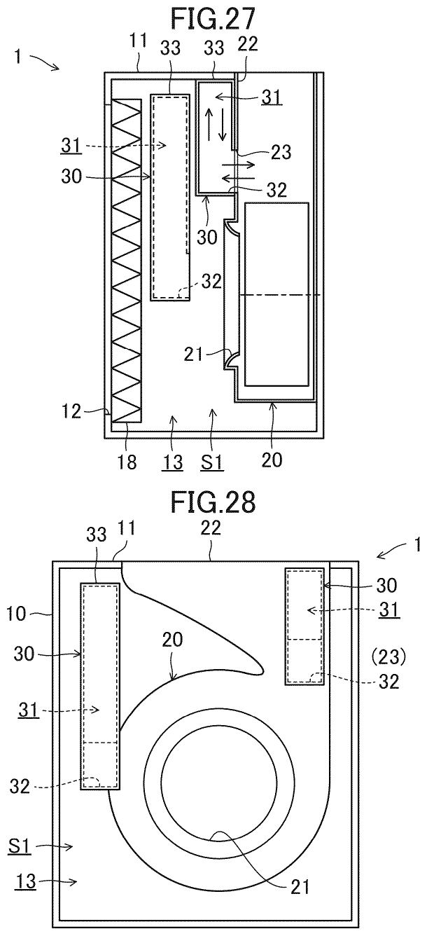

A plurality of silencers (30) are arranged in the housing (10). In the example shown in FIGS. 25 and 26, two silencers (30) are provided. The silencers (30) are arranged at positions not interfering with the humidifier (50). The configuration of the silencers (30) will be described below with reference to FIGS. 27 and 28 from which the humidifier (50) is omitted.

The left silencer (30) in FIG. 28 is arranged closer to the front side of the paper of FIG. 28 than the fan (20). The left silencer (30) has a propagation path (31) extending in the up-down direction. The left silencer (30) has an opening (32) on the back side of the paper of FIG. 28 (on the right side of FIG. 27). The left silencer (30) has a blocking part (33) on the upper side in FIG. 28.

The right silencer (30) in FIG. 28 is arranged closer to the front side of the paper of FIG. 28 than the fan (20). The right silencer (30) has a propagation path (31) extending in the up-down direction. The right silencer (30) has an opening (32) on the back side of the paper of FIG. 28 (on the right side of FIG. 27). The right silencer (30) has a blocking part (33) on the upper side in FIG. 28.

A branch port (23) is provided between the suction port (21) and the blowout port (22) of the fan (20). The branch port (23) communicates with the opening (32) of the right silencer (30) in FIG. 28. The sound generated on the blow-out side of the fan (20) enters the opening (32) of the silencer (30) through the branch port (23).

### Advantages of Tenth Embodiment

According to the features of this embodiment, it is possible to further enhance the noise reduction effect by providing the plurality of silencers (30). Further, the arrangement of the silencers (30) on the blow-out side of the fan (20) can reduce the sound generated on the blow-out side of the fan (20).

As can be seen from the foregoing description, the present disclosure is useful for an air conditioning apparatus and an air purifier.

1. An air conditioning apparatus comprising:
a housing;
a fan arranged in an inside of the housing;
a suction-side flow path between a suction opening of the housing and a suction port of the fan; and
a silencer with a tubular shape, the silencer having a propagation path through which a sound propagates, and the silencer including
an opening that is open at one end of the propagation path and communicates with the suction-side flow path, and
a blocking part that blocks an other end of the propagation path and reflects, toward the opening, the sound that has passed through the propagation path.

2. The air conditioning apparatus of claim 1, wherein
a direction in which the sound propagates through the suction-side flow path is a first direction,
a direction orthogonal to the first direction is a second direction, and
an average length of the opening of the silencer in the second direction is greater than an average length of the opening of the silencer in the first direction.

3. The air conditioning apparatus of claim 1, wherein
a sound generated in the suction-side flow path is caused by rotation of the fan.

4. The air conditioning apparatus of claim 1, wherein
a sound generated in the suction-side flow path is caused by a resonance sound due to a shape of the housing.

5. The air conditioning apparatus of claim 1, wherein
0.02<S/S0, where
S is a cross-sectional area of the opening of the silencer, and
S0 is a cross-sectional area of the suction-side flow path in a direction orthogonal to an axis of the fan.

6. The air conditioning apparatus of claim 5, wherein
S/S0<0.05.

7. The air conditioning apparatus of claim 1, wherein
a silencing chamber is arranged in the suction-side flow path,
the opening of the silencer communicates with the silencing chamber,
S1<S0 and S2<S0, where
S0 is a cross-sectional area of the silencing chamber in the direction orthogonal to an axis of the fan,
S1 is a cross-sectional area of the suction port of the fan, and
S2 is a cross-sectional area of the suction opening of the housing, and
a volume of the silencer is smaller than a volume of the silencing chamber.

8. The air conditioning apparatus of claim 7, further comprising:
a partition plate that divides the inside of the housing into
a fan chamber in which the fan is arranged and
the silencing chamber that propagates a sound on an upstream side of the fan chamber in a direction of air flow,
the partition plate having a communication port communicating with the suction port of the fan.

9. The air conditioning apparatus of claim 7, wherein
the silencer reduces a resonance sound dependent on a volume of the suction-side flow path.

10. The air conditioning apparatus of claim 1, wherein
the opening of the silencer is open in a direction, which is the same as a direction in which the sound propagates through the suction-side flow path.

11. The air conditioning apparatus of claim 1, wherein
the opening of the silencer is arranged along an outer peripheral edge of the suction port as viewed along an axis of the fan.

12. The air conditioning apparatus of claim 1, wherein
a plurality of the silencers are provided.

13. The air conditioning apparatus of claim 1, wherein
the silencer has a bent part, the bent part being a bent portion of the propagation path.

14. The air conditioning apparatus of claim 1, wherein
a length of the propagation path of the silencer is set in accordance with a sound frequency.

15. An air purifier including the air conditioning apparatus of claim 1.
